(19) United States
(12) Patent Application Publication
(10) Pub. No.: US 2014/0354520 A1
(43) Pub. Date: Dec. 4, 2014

(54) ORGANIC EL DISPLAY DEVICE

(71) Applicant: Japan Display Inc., Tokyo (JP)

(72) Inventors: Toshihiro SATO, Tokyo (JP); Masato ITO, Tokyo (JP)

(73) Assignee: Japan Display Inc., Tokyo (JP)

(21) Appl. No.: 14/291,147

(22) Filed: May 30, 2014

(30) Foreign Application Priority Data
May 31, 2013 (JP) 2013-116032

(51) Int. Cl. G09G 3/32

(52) U.S. Cl. CPC G09G 3/3233; G09G 2320/0626
USPC 345/77

(57) ABSTRACT

In an organic EL display device, pixels constituted by sub-pixels of red (R), green (G), blue (B) and white (W) are formed without using a color filter. RGB sub-pixels of RGBW sub-pixels constituting a pixel include only respective light-emitting regions of respective corresponding colors. A W sub-pixel is configured such that a plurality of partial regions constituted by different types of light-emitting regions are arranged adjacent to each other, and that the plurality of partial regions are driven by a common pixel circuit.

### CROSS-REFERENCE TO RELATED APPLICATION

The present application claims priority from Japanese application JP2013-116032 filed on May 31, 2013, the content of which is hereby incorporated by reference into this application.

### BACKGROUND OF THE INVENTION

1. Field of the Invention

The present disclosure relates to an organic electroluminescence (EL) display device.

2. Description of the Prior Art(s)

Organic EL display devices generate a plurality of colors such as red (R), green (G), and blue (B) using light emitted by organic light-emitting diodes (OLEDs) and display a color image. Each pixel which is arranged two-dimensionally in an image display region is constituted by a plurality of sub-pixels that emit light of colors different from each other. The emission intensities of the respective sub-pixels can be controlled independently of each other, and the pixels can represent various colors in accordance with a balance between these emission intensities.

As a mechanism of the generation of a plurality of colors, there are a configuration in which a white (W) emitting OLED and a color filter are combined, a configuration in which a plurality of types of OLEDs that emit respective color components such as RGB are arranged in an image display region, and the like. In the configuration in which the color filter is used among these configurations, since light is absorbed by the color filter, the use efficiency of light decreases and a reduction in power consumption is not likely to be achieved. As a countermeasure against such a problem, a configuration is proposed in which a W sub-pixel that emits white light is provided as it stands without providing a color filter, in addition to RGB sub-pixels, for example, in which the color filter is arranged.

On the other hand, the configuration in which a plurality of types of OLEDs that emit the respective color components are used is excellent in terms of the high use efficiency of light and small power consumption because light is not absorbed by the color filter. Thus, from the viewpoint of the use efficiency of light or the like, the need for providing the W sub-pixels in the configuration is reduced.

Here, when a video signal expressed by respective color signals of RGB is displayed on a display device having pixels constituted by RGBW sub-pixels, a conversion process of dividing three-color signals of RGB into four-color signals of RGBW is performed. In the conversion process, for example, components of a portion of the respective original color signals such as a luminance component are allocated to a W signal, and thus a margin occurs in the signal amplitudes of the respective RGB color signals or the drive capability of a drive circuit after the conversion. An improvement in finer gradation expression or color reproduction can be achieved using such a margin. From such a viewpoint, it is useful in the organic EL display device to form a pixel configuration in which the W sub-pixel is added to the RGB sub-pixels constituted by OLEDs that emit the respective color components.

### SUMMARY OF THE INVENTION

The W sub-pixel can be realized by an OLED having an organic light-emitting layer that emits a white color or a configuration in which white light is obtained using the additive mixture of colors of RGB by laminating OLEDs of respective emission colors of R, G, and B. However, when the OLED having an organic light-emitting layer that emits a while color is formed, there is a problem in that evaporation masks, materials, and processes are made to be necessary in addition to the formation of the OLED of the respective emission colors of RGB. In addition, even when a laminated structure of the OLED of RGB is formed, a problem such as an increase in the number of processes is caused.

It is desirable to provide an organic EL display device capable of easily creating a pixel constituted by RGBW sub-pixels.

(1) According to an embodiment of the present disclosure, there is provided an organic EL display device in which three or more types of light-emitting regions having organic light-emitting elements that emit light in colors different from each other formed therein are arranged two-dimensionally in an image display region, wherein a plurality of pixels arranged in the image display region are each constituted by a plurality of types of sub-pixels whose emission intensities are controlled independently of each other, and the plurality of types of sub-pixels includes a plurality of types of simple sub-pixels, provided for respective types of the light-emitting regions, which each include only one type of the light-emitting region, and a composite sub-pixel in which a plurality of partial regions constituted by different types of the light-emitting regions are arranged adjacent to each other, and the plurality of partial regions are driven by a common pixel circuit.

(2) In the organic EL display device according to the above (1), one direction in which the pixels form a column in a two-dimensional array of the pixels may be set to a specific array direction, the simple sub-pixels of the plurality of pixels that form a column in the specific array direction maybe lined up along the specific array direction, and the composite sub-pixel of each of the pixels may be adjacent to all of the simple sub-pixels of the pixel.

(3) In the organic EL display device according to the above (2), the composite sub-pixels of the plurality of pixels that form a column in the specific array direction may be lined up on a straight line along the specific array direction.

(4) The organic EL display device according to the above (1) to (3) may further include a drive circuit that causes the composite sub-pixel to emit light at an intensity according to a luminance component of a video signal, and causes the simple sub-pixels to emit light in accordance with remaining components of the video signal.

(5) In the organic EL display device according to the (1) to (4), the light-emitting regions may be of three types that emit light in first to third colors, the plurality of types of simple sub-pixels may be a first simple sub-pixel that emits light in the first color, a second simple sub-pixel that emits light in the second color, and a third simple sub-pixel that emits light in the third color, and the composite sub-pixel may emit light in a fourth color obtained by mixing light emissions of the respective partial regions.

(6) In the organic EL display device according to the above (5), the first color may be red, the second color may be green, and the third color may be blue, and the composite sub-pixel may be constituted by first to third partial regions, and the fourth color may be white.

(7) In the organic EL display device according to the above (5) or (6), the composite sub-pixel may be constituted by the first to third partial regions, the first partial region may be adjacent to the first simple sub-pixel, and emit light in the same color, the second partial region may be adjacent to the second simple sub-pixel, and emit light in the same color, and the third partial region may be adjacent to the third simple sub-pixel, and emit light in the same color.

(8) In the organic EL display device according to the above (1) to (7), the plurality of types of light-emitting regions may be formed in a stripe array in which a plurality of stripes having the light-emitting regions of the same type lined up on a straight line are arranged in parallel in the image display region.

(9) The organic EL display device according to the above (8) may further include a power supply line, extending along each of the stripes, which supplies a drive current to the organic light-emitting element of the simple sub-pixel constituted by the light-emitting region belonging to the stripe, and the power supply line corresponding to any one of the plurality of types of light-emitting regions may be formed to be thicker than the power supply lines corresponding to other types, and supplies a drive current to the organic light-emitting element of the composite sub-pixel in addition to the simple sub-pixel.

(10) In the organic EL display device according to the above (1) to (9), a partial region in the plurality of types of partial regions may have a larger area as a deterioration rate of the organic light-emitting element formed in the partial region is larger.

According to the present disclosure, a process of forming the composite sub-pixel serving as the W sub-pixel is communized with a process of forming the simple sub-pixels equivalent to the RGB sub-pixels, and the organic EL display device having a pixel constituted by the RGBW sub-pixels is easily manufactured.

### BRIEF DESCRIPTION OF THE DRAWINGS

FIG. 1 is a schematic diagram illustrating a schematic configuration of an organic EL display device according to an embodiment of the present disclosure.

FIG. 2 is a plan view schematically illustrating a portion of a pixel array section in an organic EL display device according to a first embodiment of the present disclosure.

FIG. 3 is a schematic diagram illustrating a schematic circuit configuration of a portion of the pixel array section in the organic EL display device according to the first embodiment of the present disclosure.

FIG. 4 is a schematic diagram illustrating the arrangement of sub-pixels in the pixel array section according to the first embodiment of the present disclosure.

FIG. 5 is a schematic diagram illustrating another example of the arrangement of the sub-pixels in the pixel array section according to the embodiment of the present disclosure.

FIG. 6 is a schematic diagram illustrating still another example of the arrangement of the sub-pixels in the pixel array section according to the embodiment of the present disclosure.

FIG. 7 is a plan view schematically illustrating a portion of a pixel array section in an organic EL display device according to a second embodiment of the present disclosure.

FIG. 8 is a schematic diagram illustrating a schematic circuit configuration of a portion of the pixel array section in the organic EL display device according to the second embodiment of the present disclosure.

### DETAILED DESCRIPTION OF THE INVENTION

Hereinafter, embodiments of the present disclosure will be described with reference to the accompanying drawings.

### First Embodiment

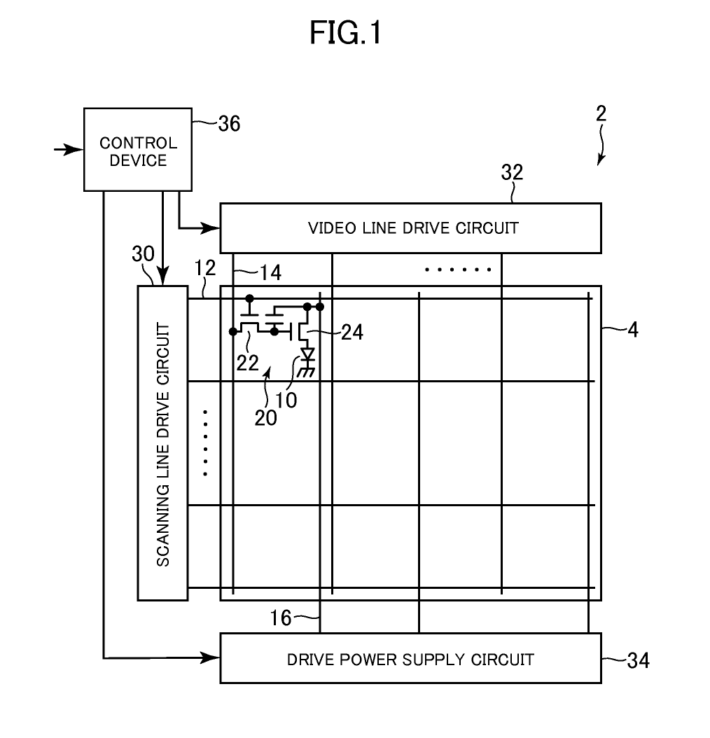

FIG. 1 is a schematic diagram illustrating a schematic configuration of an organic EL display device 2 according to a first embodiment of the present disclosure. The organic EL display device 2 includes a pixel array section 4 and a drive section.

The pixel array section 4 includes an image display region in which pixels are arranged two-dimensionally and displays an image. Three types of light-emitting regions of R light emission, G light emission and B light emission are arranged two-dimensionally in the image display region. OLEDs which are organic light-emitting elements that emit light in corresponding colors are formed in the light-emitting regions of the respective colors. The pixel is constituted by a plurality of types of sub-pixels formed of the light-emitting regions. In the present embodiment, the pixels are arranged in a matrix display region, and each of the pixels is constituted by four types of sub-pixels of RGBW.

In addition, a thin film transistor (TFT) for performing active matrix driving on an OLED 10, a scanning signal line 12, a video signal line 14, a power supply line 16 and the like are also formed in the image display region. Specifically, a pixel circuit 20 including a turn-on TFT 22 and a drive TFT 24 is formed for each sub-pixel. The scanning signal line 12 extends in a direction along the lineup (pixel row) of the pixels in a horizontal direction, and is connected in common to the gates of the turn-on TFTs of a plurality of sub-pixels belonging to the pixel row. In addition, the video signal line 14 and the power supply line 16 extend in a direction along the lineup (pixel column) of the pixels in a vertical direction.

The organic EL display device 2 includes a scanning line drive circuit 30, a video line drive circuit 32, a drive power supply circuit 34, a control device 36 and the like, as a drive section.

The scanning line drive circuit 30 is connected to a plurality of scanning signal lines 12. The scanning line drive circuit 30 selects the scanning signal lines 12 in order in accordance with a timing signal which is input from the control device 36, and applies a voltage for turning on a TFT to the selected scanning signal line 12. For example, the scanning line drive circuit 30 is configured to include a shift register, and the shift register starts to operate by receiving a trigger signal from the control device 36, sequentially selects the scanning signal lines 12 in order along a vertical scanning direction, and outputs a scanning pulse to the selected scanning signal line 12.

The video line drive circuit 32 is connected to a plurality of video signal lines 14. The video line drive circuit 32 receives an input of a video signal from the control device 36, and outputs a voltage based on the video signal of the selected pixel row to each video signal line 14, in conformity to the selection of the scanning signal line 12 by the scanning line drive circuit 30. The voltage is written to the pixel circuit through the turn-on TFT 22 in the selected pixel row. The drive TFT 24 supplies a current based on the written voltage from the power supply line 16 to the OLED 10, whereby the OLED 10 of a pixel corresponding to the selected scanning signal line 12 emits light. This is equivalent to horizontal scanning of a raster image. Incidentally, the above-mentioned operation of the scanning line drive circuit 30 is equivalent to vertical scanning.

The drive power supply circuit 34 is connected to the power supply line 16, and supplies a drive current to the OLED 10 through the power supply line 16 and the drive TFT 24 of the selected pixel row.

The control device 36 includes an arithmetic processing circuit such as a CPU (Central Processing Unit) and a storage section constituted by a memory element such as a ROM (Read Only Memory) and a RAM (Random Access Memory). A video signal is input to the control device 36. For example, when the organic EL display device 2 constitutes a display section of a computer or a portable terminal, the video signal is input from the computer or the like of a main body to the organic EL display device 2. In addition, when the organic EL display device 2 constitutes a television receiver, the video signal is received by an antenna or a tuner which is not shown in the drawing. The control device 36 executes a variety of processing by the CPU reading out and executing programs stored in a memory. Specifically, when a video signal to be input is an RGB signal, the control device 36 converts the signal into an RGBW signal. In addition, the control device 36 performs a variety of image signal processing, such as color adjustment, on the video signal and outputs the resultant to the video line drive circuit 32. In addition, the control device 36 generates a timing signal for synchronization of circuits of the drive section on the basis of the input video signal and output the generated signal to the relevant circuit.

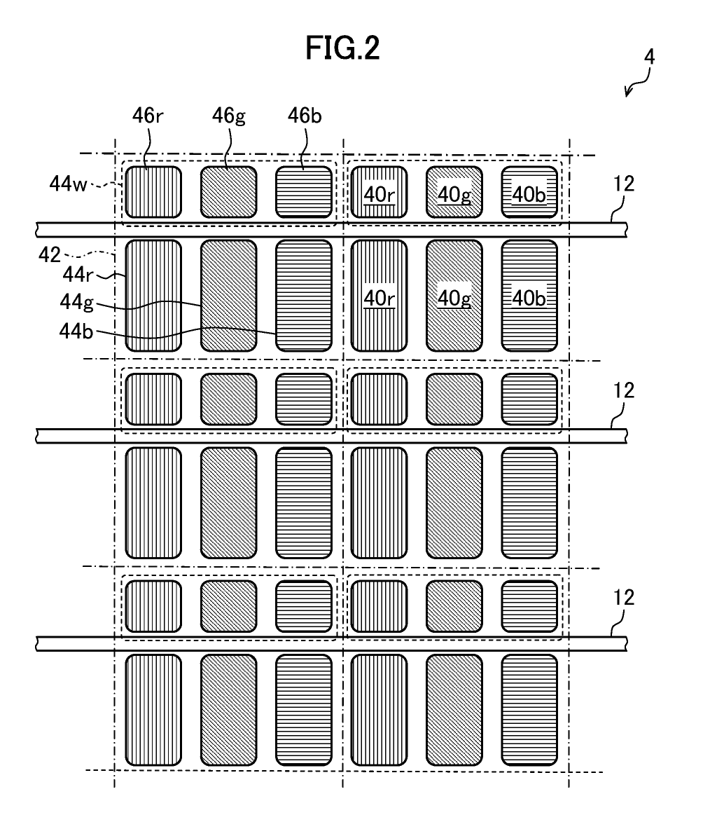

FIG. 2 is a plan view schematically illustrating a portion of the pixel array section 4. Light-emitting regions 40r, 40g, and 40b of respective colors of RGB are arranged in a stripe pattern in the image display region. Specifically, a plurality of stripes in which the light-emitting regions 40 of the same type are lined up on a straight line along a column direction are arranged in parallel in the image display region. An R stripe constituted by the R light-emitting regions 40r, a G stripe constituted by the G light-emitting regions 40g, and a B stripe constituted by the B light-emitting regions 40b are periodically arranged in a certain order in a row direction.

Each pixel 42 includes two R light-emitting regions 40r adjacent to each other, two G light-emitting regions 40g adjacent to each other, and two B light-emitting regions 40b adjacent to each other. For example, the R light-emitting region 40r, the G light-emitting region 40g and the B light-emitting region 40b which are located at a lower side in the column direction in each pixel 42 constitute RGB sub-pixels 44r, 44g, and 44b, respectively. On the other hand, the R light-emitting region 40r, the G light-emitting region 40g and the B light-emitting region 40b which are located at an upper side in the column direction constitute partial regions 46 (46r, 46g, and 46b) of a W sub-pixel 44w, respectively. That is, the RGB sub-pixels 44r, 44g, and 44b are provided for each type of the light-emitting region, and are sub-pixels (simple sub-pixels) including only one type of light-emitting region. On the other hand, the W sub-pixel 44w is a sub-pixel (composite sub-pixel) in which the partial regions 46r, 46g, and 46b constituted by different types of light-emitting regions are arranged adjacent to each other.

Four sub-pixels 44 of each pixel 42 are configured to be able to control emission intensities independently of each other. Specifically, regarding the RGB sub-pixels 44r, 44g, and 44b, lower electrodes (anodes) of OLEDs which are formed in the light-emitting regions 40r, 40g, and 40b are separated from each other, and these lower electrodes are connected to separate pixel circuits. On the other hand, in the W sub-pixel 44w, lower electrodes of OLEDs which are formed in the light-emitting regions 40r, 40g, and 40b are continuous integrated electrodes, and the lower electrodes are connected to one pixel circuit. Thereby, the OLEDs of three partial regions 46 of the W sub-pixel 44w are driven in common, the W sub-pixel 44w emits light in a color obtained by mixing light emissions of these partial regions 46. In the present embodiment, the light emission color of the W sub-pixel 44w is designed so as to be white (W).

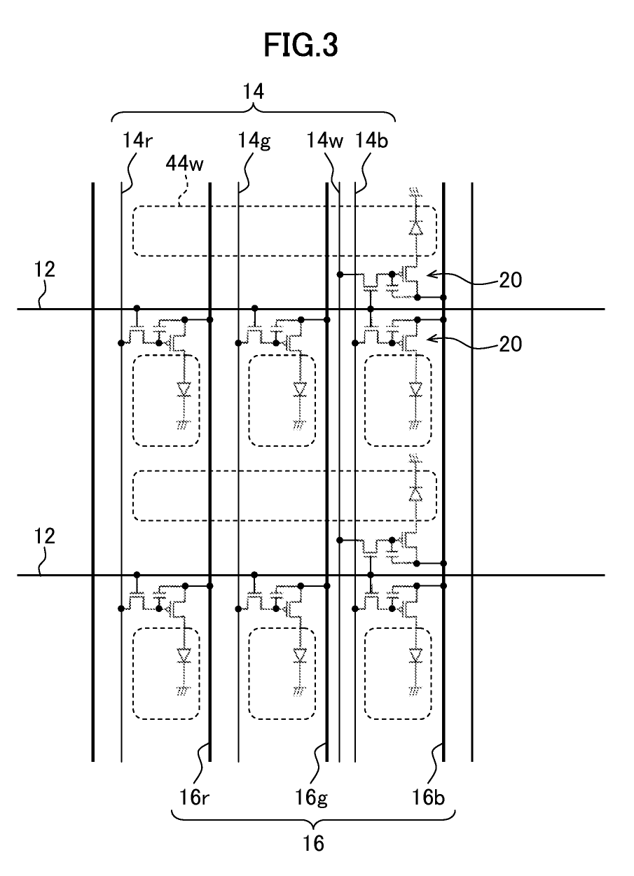

FIG. 3 is a schematic diagram illustrating a schematic circuit configuration of a portion of the pixel array section 4. As described above, the pixel circuit 20 is provided in each of four sub-pixels 44 of each pixel 42. Four pixel circuits 20 of each pixel 42 are connected to the common scanning signal line 12. Here, by setting the position of the scanning signal line 12 in a vertical direction to, for example, a boundary between the W sub-pixel 44w and the RGB sub-pixels 44r, 44g, and 44b of each pixel 42 or the vicinity of the boundary, the pixel circuits 20 of the W sub-pixel 44w are arranged at a higher position than the scanning signal line 12, and the pixel circuits 20 of the RGB sub-pixels 44r, 44g, and 44b are arranged at a lower position than the scanning signal line 12, that is, a plurality of pixel circuits 20 of each pixel 42 are arranged so as to be divided to both sides of the scanning signal line 12, whereby the layout of the pixel circuits 20 is facilitated, and a reduction in pixel size is facilitated accordingly.

The drains of the turn-on TFTs 22 of the four pixel circuits are connected to the separate video signal lines 14. Specifically, the R sub-pixel 44r of each pixel in the pixel column is connected to a video signal line 14r of the video signal lines 14 extending in a pixel column direction, the G sub-pixel 44g of each pixel in the pixel column is connected to a video signal line 14g, the B sub-pixel 44b of each pixel in the pixel column is connected to a video signal line 14b, and the W sub-pixel 44w of each pixel in the pixel column is connected to a video signal line 14w.

The power supply line 16 is provided for each stripe of RGB in each pixel column. For example, the power supply lines 16 can be arranged one by one in the boundary between the stripes. The lower electrode of the OLED 10 of the R sub-pixel 44r of each pixel in the pixel column is connected to a power supply line 16r arranged in the vicinity of the R stripe through the drive TFT 24. Similarly, the OLEDs 10 of the G sub-pixel 44g and the B sub-pixel 44b of each pixel in the pixel column are connected to power supply lines 16g and 16b arranged in the vicinity of the G stripe and the B stripe.

The OLEDs 10 of the W sub-pixel 44w are connected to any of the power supply lines 16r, 16g, and 16b. For example, in FIG. 3, the power supply line 16b is used in common for the supply of a drive current to the B sub-pixel 44b and the supply of a drive current to the W sub-pixel 44w. The power supply line 16, such as the power supply line 16b, which is used in common in a plurality of types of sub-pixels 44 has the possibility of the flow of a larger current than those in other power supply lines 16. Therefore, it is preferable that the upper limit of current density be set to be to the same extent as the other power supply lines 16 by forming the power supply lines so as to be thicker than the other power supply lines 16.

In the pixel configuration of the aforementioned pixel array section 4, organic light-emitting layers emit three colors of RGB, and these layers are formed in regions different from each other by separate processes. That is, it is not necessary to form a white organic light-emitting layer in addition to the organic light-emitting layers of RGB, or to create a structure, in which white light emission can be made, by laminating the organic light-emitting layers of RGB, in order to create the W sub-pixel 44w. Therefore, the number of evaporation masks, materials, and processes which are necessary for manufacturing can be suppressed to the same extent as the pixel configuration constituted by RGB sub-pixels.

Meanwhile, similarly to the pixel configuration of the related art which is constituted by three types of sub-pixels of RGB, the upper electrodes (cathodes) of four types of sub-pixels 44 can be set to a common electrode. In addition, a hole transport layer (HTL) and an electron injection layer (EIL) constituting an OLED can also be used in common in all the sub-pixels similarly to the configuration of the related art. In addition, since the organic light-emitting layers of R and G emit light with energy lower than that of the organic light-emitting layer of B, there is no influence even when the organic light-emitting layer of B is laminated on the organic light-emitting layers of the light-emitting regions of R and G. Thus, the organic light-emitting layer of B can also be formed in common to all the sub-pixels.

As described above, the control device 36 converts a video signal composed of RGB signals to generate a video signal composed of RGBW signals, and the generated signal is written to each pixel 42 through the video line drive circuit 32. The conversion of the RGB signal into the RGBW signal can be performed using a known technique. For example, a W signal is set to have an intensity according to the luminance component (Y component) of the video signal, and remaining components obtained by subtracting the W signal component from the video signal are allocated to respective color signals of RGB after the conversion.

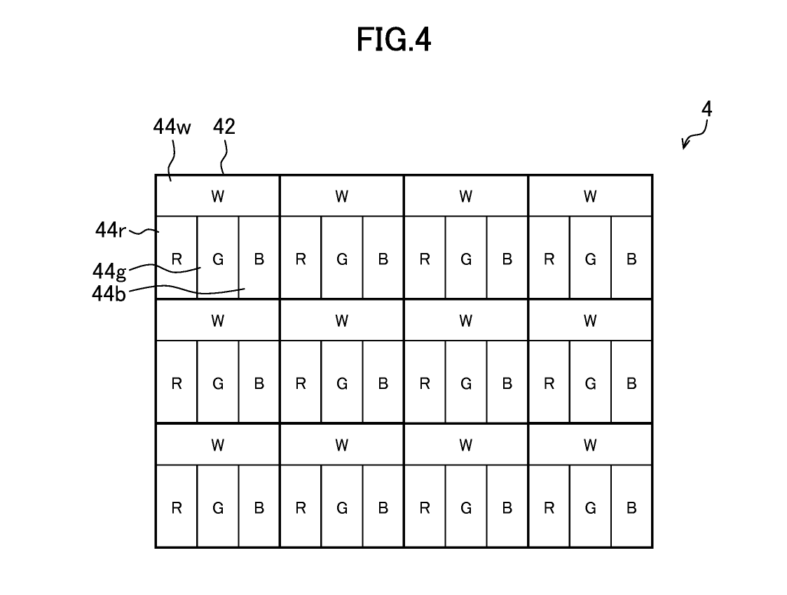

The pixels 42 according to the above-mentioned embodiment have a matrix array, and are lined up so as to form rows and columns in the horizontal direction and the vertical direction of the image display region. Here, when the horizontal direction is set to a specific array direction, a pixel row corresponds to a plurality of pixels that form a row in the specific array direction. The simple sub-pixels of a plurality of pixels 42 constituting the pixel row, that is, the RGB sub-pixels 44r, 44g, and 44b are lined up along the specific array direction, and the composite sub-pixel of each pixel 42, that is, the W sub-pixel 44w is adjacent to all of the simple sub-pixels of the pixel. Further, the composite sub-pixels of a plurality of pixels 42 constituting the pixel row are lined up on a straight line along the specific array direction. FIG. 4 is a schematic diagram in which the arrangement of the sub-pixels is illustrated in a more simplified representation than shown in FIG. 2.

In the layout of the pixels 42, the W sub-pixel 44w always emits light in accordance with a luminance component when the pixel emits light, and the partial regions 46r, 46g, and 46b constituting the W sub-pixel 44w simultaneously emits light. Thus, in a region where an image is displayed by light emission, W sub-pixels 44w adjacent to each other in a specific array direction emit light, and thus the spatial discontinuity of light emission between pixels adjacent to each other in the specific array direction is reduced. In addition, regarding a direction intersecting the specific array direction, at least any of the RGB sub-pixels 44r, 44g, and 44b basically emits light in each pixel 42, and thus an interval between the W sub-pixel 44w of the pixel 42 and the W sub-pixel 44w of its adjacent pixel can be expected to be bridged by the light-emitting region. Thus, the spatial discontinuity of light emission between pixels adjacent to each other in a direction intersecting the specific array direction is also reduced. That is, the unnecessary roughness of an image due to a spatial high-frequency component accompanied by a discrete display in a plurality of types of sub-pixels is reduced by improving the microscopic space continuity of light emission between light-emitting pixels adjacent to each other, and thus an effect is obtained in which an image quality is improved due to the approach of an image representation to the original texture of a display object or the like, or the visibility of a fine display is improved.

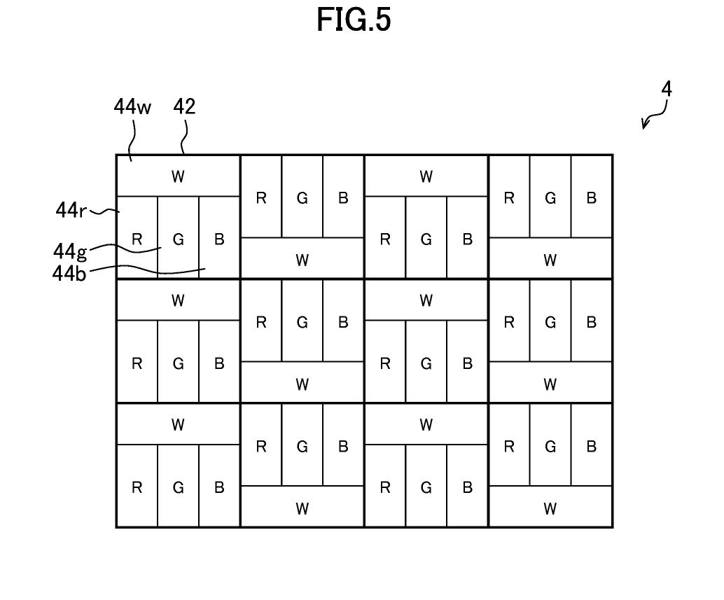

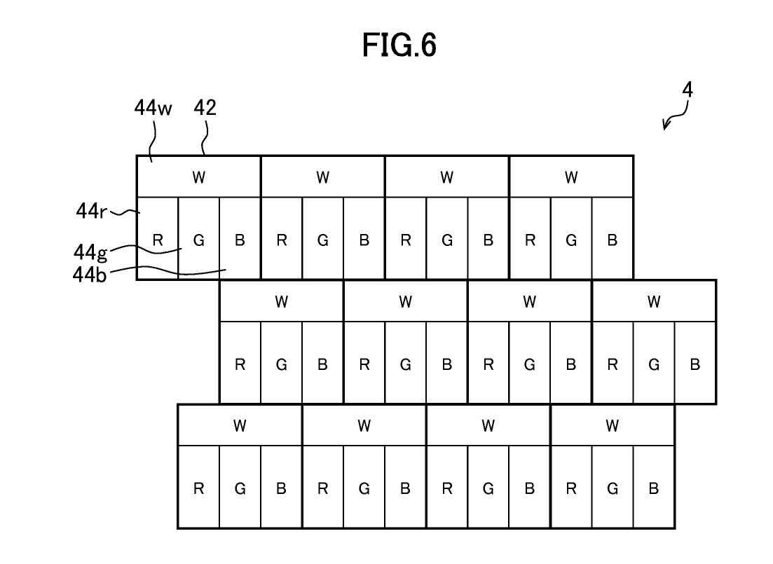

FIGS. 5 and 6 are schematic diagrams illustrating examples of other arrangements of the sub-pixels in which the above effect is obtained. In the examples of FIGS. 5 and 6, the specific array direction is a horizontal direction. In the example of FIG. 5, the RGB sub-pixels of each pixel row are lined up approximately along the specific array direction, and the W sub-pixel of each pixel is adjacent to all of the RGB sub-pixels of the pixel. In this point, the configuration of FIG. 5 is in common with the configuration of FIG. 4. On the other hand, in the configuration of FIG. 5, the configuration of W sub-pixels of a plurality of pixels in each pixel row is different from the configuration of FIG. 4, in that the positions thereof in a vertical direction within the pixels are alternately switched, and that the sub-pixels are not lined up on a straight line along the specific array direction. However, when notice is taken of the W sub-pixels in the pixel rows adjacent to each other, the W sub-pixels are approximately continuously arranged in the specific array direction.

In the example of FIG. 6, the light-emitting regions of RGB are not arranged in a stripe pattern, but the light-emitting regions of RGB are shifted in a horizontal direction between the pixel rows adjacent to each other. On the other hand, in the example of FIG. 6, the RGB sub-pixels of each pixel row are lined up along the specific array direction, the W sub-pixel of each pixel is adjacent to all of the RGB sub-pixels of the pixel. Further, the W sub-pixels a plurality of pixels in each pixel row are lined up on a straight line along the specific array direction. Thus, the configuration of FIG. 6 has basically the same effect as that of the configuration of FIG. 4.

In the above-mentioned embodiment, an example has been described in which the composite sub-pixel emits a white color, but there is no limitation thereto. For example, the color to be emitted may be a color which is slightly shifted from a white color, and may be other colors of yellow (Ye) emission or the like.

In the above-mentioned embodiment, in each pixel 42, the R partial region 46r and the R sub-pixel 44r are adjacent to each other so as to be lined up in the pixel column direction, the G partial region 46g and the G sub-pixel 44g are adjacent to each other so as to be lined up in the pixel column direction, and the B partial region 46b and the B sub-pixel 44b are adjacent to each other so as to be lined up in the pixel column direction. In such a configuration, the partial region 46 and the sub-pixel 44 which are lined up in the pixel column direction are formed by light-emitting regions of the same color, and the above-mentioned light-emitting regions can be arranged in a stripe pattern. On the other hand, a layout is possible in which the partial region 46 and the sub-pixel 44 which are lined up in the pixel column direction are light-emitting regions of different colors.

In addition, the number of types of the simple sub-pixels may be more than three, and the number of types of the partial regions constituting the composite sub-pixel may be smaller than the number of types of the simple sub-pixel. For example, when the simple sub-pixels are three types of RGB, the types of the partial regions constituting the composite sub-pixel can be set to two types of RG, or it is possible that the simple sub-pixel is set to four types of RGB and Ye and the types of the partial regions constituting the composite sub-pixel is set to three types of RGB.

In addition, the areas of the partial regions 46r, 46g, and 46b constituting the W sub-pixel 44w may be set to be wide as the deterioration rate of the OLED formed in each partial region is large. Generally, when a current flowing through the OLED is made to be constant and the area of the organic light-emitting layer is increased, a current density decreases, and the deterioration of the organic light-emitting layer is delayed. Since the light-emitting times of the partial regions 46r, 46g, and 46b are in common with each other, the uniformity of lifetime of the partial regions 46r, 46g, and 46b can be achieved by regulating the area ratio of the partial regions 46r, 46g, and 46b, whereby the time-dependent color shift of the W sub-pixel 44w can be suppressed, or the lifetime improvement of the W sub-pixel 44w and the pixel array section 4 can be achieved. Specifically, since it is known that the time-dependent change in the luminance of the B organic light-emitting layer is larger than those of organic light-emitting layers of other colors, the area of the partial region 46b of B can be made to be larger than those of the partial regions 46r and 46g of R and G.

Meanwhile, when a current flowing through the OLED is constant, it is simply considered that emission intensity is not changed even in a case where the area of the organic light-emitting layer is changed. However, for example, a plurality of OLEDs for respective partial regions 46 are connected in parallel to one pixel circuit 20 in the W sub-pixel 44w, the balance of a current between the OLEDs is changed due to various factors when the area of a certain partial region 46 is changed, and thus it is also considered that the current flowing through the OLED does not become constant. Thus, it is preferable that the areas of a plurality of partial regions 46 for realizing an improvement in lifetime be set in consideration of an influence such as a change in lifetime associated with such a current change or a change in the color balance associated with the current change.

### Second Embodiment

Hereinafter, an organic EL display device 2 according to a second embodiment of the present disclosure will be described. Components common to those of the first embodiment among components of the present embodiment are denoted by the same reference numerals and signs, a description of the components will be basically omitted, and differences from the first embodiment will be chiefly described.

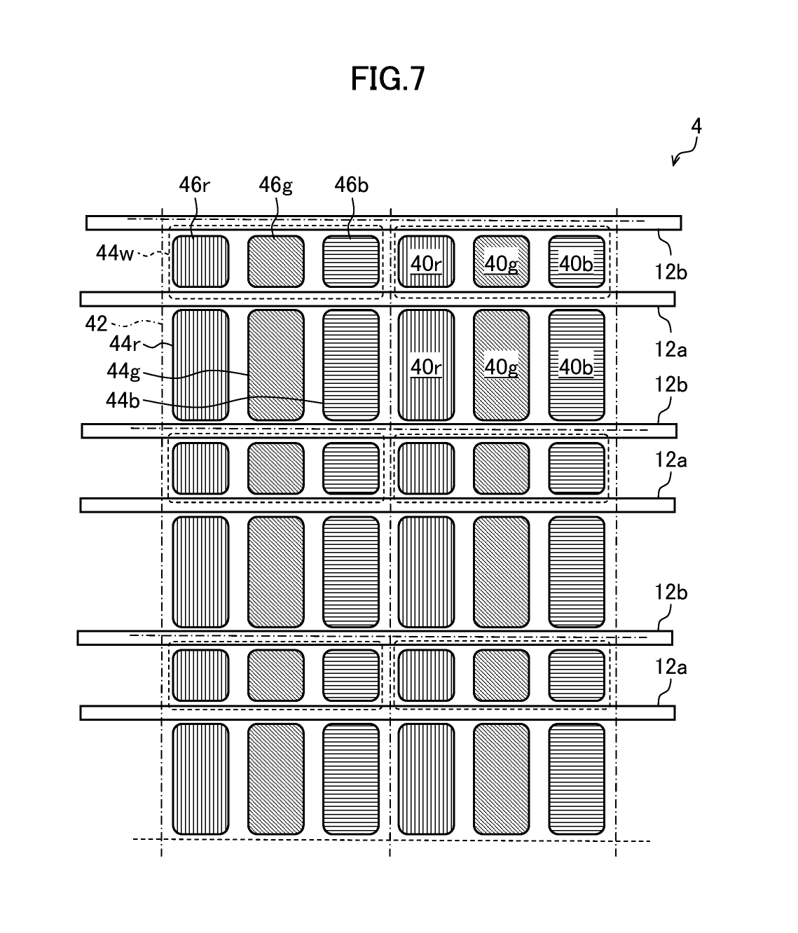

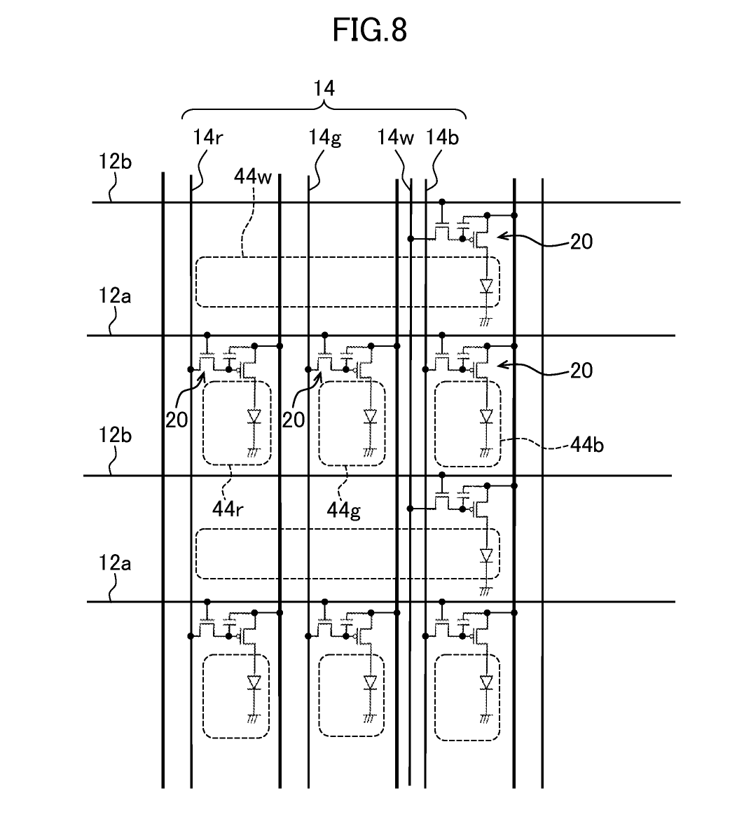

FIG. 7 is a plan view schematically illustrating a portion of the pixel array section 4 in the organic EL display device 2 of the present embodiment. In addition, FIG. 8 is a schematic diagram illustrating a schematic circuit configuration of a portion of the pixel array section 4 in the organic EL display device 2 of the present embodiment. In the first embodiment, one scanning signal line 12 is arranged in each pixel row, and all the pixel circuits 20 of each pixel 42 are connected to the scanning signal line 12. On the other hand, in the present embodiment, two scanning signal lines 12 are arranged in each pixel row, the pixel circuits 20 of the RGB sub-pixels 44r, 44g, and 44b are connected to a first scanning signal line 12a, and the pixel circuit 20 of the W sub-pixel 44w is connected to a second scanning signal line 12b.

In such a configuration, the W sub-pixel 44w can be caused to emit light independently of the RGB sub-pixels 44r, 44g, and 44b. For example, the drive section performs duty driving on the W sub-pixel 44w using the scanning signal line 12b, and thus an improvement in moving image characteristics can be achieved.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An organic EL display device in which three or more types of light-emitting regions having organic light-emitting elements that emit light in colors different from each other formed therein are arranged two-dimensionally in an image display region,
wherein a plurality of pixels arranged in the image display region are each constituted by a plurality of types of sub-pixels whose emission intensities are controlled independently of each other, and
the plurality of types of sub-pixels includes
a plurality of types of simple sub-pixels, provided for respective types of the light-emitting regions, which each include only one type of the light-emitting region, and
a composite sub-pixel in which a plurality of partial regions constituted by different types of the light-emitting regions are arranged adjacent to each other, and the plurality of partial regions are driven by a common pixel circuit.

2. The organic EL display device according to claim 1, wherein one direction in which the pixels form a column in a two-dimensional array of the pixels is set to a specific array direction,
the simple sub-pixels of the plurality of pixels that form a column in the specific array direction are lined up along the specific array direction, and
the composite sub-pixel of each of the pixels is adjacent to all of the simple sub-pixels of the pixel.

3. The organic EL display device according to claim 2, wherein the composite sub-pixels of the plurality of pixels that form a column in the specific array direction are lined up on a straight line along the specific array direction.

4. The organic EL display device according to claim 1, further comprising a drive circuit that causes the composite sub-pixel to emit light at an intensity according to a luminance component of a video signal, and causes the simple sub-pixels to emit light in accordance with remaining components of the video signal.

5. The organic EL display device according to claim 1, wherein the light-emitting regions are of three types that emit light in first to third colors,
the plurality of types of simple sub-pixels area first simple sub-pixel that emits light in the first color, a second simple sub-pixel that emits light in the second color, and a third simple sub-pixel that emits light in the third color, and
the composite sub-pixel emits light in a fourth color obtained by mixing light emissions of the respective partial regions.

6. The organic EL display device according to claim 5, wherein the first color is red, the second color is green, and the third color is blue, and
the composite sub-pixel is constituted by first to third partial regions, and the fourth color is white.

7. The organic EL display device according to claim 5, wherein the composite sub-pixel is constituted by the first to third partial regions,
the first partial region is adjacent to the first simple sub-pixel, and emits light in the same color,
the second partial region is adjacent to the second simple sub-pixel, and emits light in the same color, and
the third partial region is adjacent to the third simple sub-pixel, and emits light in the same color.

8. The organic EL display device according to claim 1, wherein the plurality of types of light-emitting regions are formed in a stripe array in which a plurality of stripes having the light-emitting regions of the same type lined up on a straight line are arranged in parallel in the image display region.

9. The organic EL display device according to claim 8, further comprising a power supply line, extending along each of the stripes, which supplies a drive current to the organic light-emitting element of the simple sub-pixel constituted by the light-emitting region belonging to the stripe,
wherein the power supply line corresponding to any one of the plurality of types of light-emitting regions is formed to be thicker than the power supply lines corresponding to other types, and supplies a drive current to the organic light-emitting element of the composite sub-pixel in addition to the simple sub-pixel.

10. The organic EL display device according to claim 1, wherein a partial region in the plurality of types of partial regions has a larger area as a deterioration rate of the organic light-emitting element formed in the partial region is larger.
